(19) United States
(12) Patent Application Publication
(10) Pub. No.: US 2025/0156257 A1
(43) Pub. Date: May 15, 2025

(54) FUSING HARDWARE AND SOFTWARE EXECUTION FOR BEHAVIOR ANALYSIS AND MONITORING

(71) Applicant: Aurora Labs Ltd., Tel Aviv (IL)

(72) Inventors: Stojancho Ganchev, Kavadarci (MK); Boris Tanchovski, Skopje (MK); Marin Todosovski, Skopje (MK)

(73) Assignee: Aurora Labs Ltd., Tel Aviv (IL)

(21) Appl. No.: 18/945,354

(22) Filed: Nov. 12, 2024

Related U.S. Application Data
(60) Provisional application No. 63/598,244, filed on Nov. 13, 2023.

(51) Int. Cl. G06F 11/07; G06F 11/36; G06F 21/55

(52) U.S. Cl. CPC G06F 11/0751; G06F 11/3636; G06F 21/554

(57) ABSTRACT

Disclosed herein are techniques for detecting anomalous computing environment behavior. Techniques include fusing computer code parameters with hardware performance data associated with at least one device to form a kernel, the computer code parameters being associated with computer code configured for the at least one device; inputting the kernel to a trained model configured to detect execution performance anomalies of the at least one device, the trained model having been trained with a plurality of reference data patterns; and receiving, from the trained model, a detection output based on the kernel, the detection output indicating an anomalous behavior.

### CROSS-REFERENCE TO RELATED APPLICATIONS

This application claims priority to U.S. Provisional Patent App. No. 63/598,244, filed on Nov. 13, 2023, which is incorporated herein by reference in its entirety.

### TECHNICAL FIELD

The subject matter described herein generally relates to techniques for improving software and hardware code execution. Such techniques may be applied to vehicle software and systems, as well as to various other types of Internet-of-Things (IoT) or network-connected systems that utilize controllers such as electronic control units (ECUs) or other controllers or devices. For example, certain disclosed embodiments are directed to training and using models to mitigate software bugs, malfunctions, attacks, and inefficiencies.

### BACKGROUND

Many IoT devices exist within systems or are connected to other devices. Sometimes, an IoT device can suffer from a disruption, such as a bug, error, inefficiency, malfunction, disfunction, attack, and the like. Not only can this disrupt the immediately affected device, but it can have ripple effects and disrupt other devices to which it is connected. Unfortunately, many such disruptions may have effects that are imperceivable to human observers, and thus go unaddressed. Even for disruptions that are identified, establishing a source of a disruption can be extraordinarily resource intensive, requiring not just large amounts of human resources, but also computing resources, especially due to the cumbersome and crude configurations and abilities of existing techniques.

In view of the technical deficiencies of current systems, there is a need for improved systems and techniques for analyzing, understanding, and remediating hardware and/or software behavior. The techniques discussed below offer many technological improvements in terms of speed, accuracy, efficiency, verifiability, reliability, resiliency, and usability. For example, according to some techniques, hardware information and software information may be fused, enabling the training of improved models, which can more effectively identify, analyze, and diagnose software bugs, errors, hardware-disruptive code, or the like, which may cause technical problems for devices and/or systems. Such models can also generate insightful output related to these issues, allowing for more rapid and appropriately tailored software and hardware remediation. These and other technical advancements and advantages are discussed below.

### SUMMARY

Some disclosed embodiments describe non-transitory computer-readable media, systems, and methods for detecting anomalous computing environment behavior. For example, in an exemplary embodiment, a method may include fusing computer code parameters with hardware performance data associated with at least one device to form a kernel, the computer code parameters being associated with computer code configured for the at least one device; inputting the kernel to a trained model configured to detect execution performance anomalies of the at least one device, the trained model having been trained with a plurality of reference data patterns; and receiving, from the trained model, a detection output based on the kernel, the detection output indicating an anomalous behavior.

In accordance with further embodiments, the trained model may detect the anomalous behavior based on the kernel, the anomalous behavior including an execution performance anomaly associated with computer code.

In accordance with further embodiments, the detection output may indicate a particular portion of the computer code precipitating the execution performance anomaly.

In accordance with further embodiments, the computer code may be defined by at least two distinct execution points and the hardware performance data may be associated with applying the computer code to the at least one device.

In accordance with further embodiments, the at least two distinct execution points may be represented by two distinct functions.

In accordance with further embodiments, applying the computer code to the at least one device may include executing the computer code on the at least one device.

In accordance with further embodiments, the hardware performance data may be based on a first hardware performance measurement determined when a first portion of the computer code associated with one of the two distinct execution points is executed and a second hardware performance measurement determined when a second portion of the computer code associated with the other of the two distinct execution points is executed.

In accordance with further embodiments, the hardware performance data may be based on a difference between the first hardware performance measurement and the second hardware performance measurement.

In accordance with further embodiments, the hardware performance data may include at least one hardware performance measurement determined when a portion of the computer code is executed between the two distinct execution points.

In accordance with further embodiments, the hardware performance data may include at least one value measured by a sensor, the at least one value being based on functioning of the at least one device based on the computer code.

In accordance with further embodiments, the at least one value may include a voltage value, a current value, a heat value, a light value, or a communication interface usage value.

In accordance with further embodiments, the computer code parameters may include at least one of one or more instruction cycles, one or more branch jumps, memory usage, or an amount of time.

In accordance with further embodiments, the at least one device may comprise a virtual device.

In accordance with further embodiments, the at least one device may comprise a processor of a controller.

Some disclosed embodiments describe non-transitory computer-readable media, systems, and methods for generating a kernel for a model. For example, in an exemplary embodiment, a method may include representing computer code as a group of execution paths by: collecting traces associated with the computer code and tracking symbols representing portions of the computer code; determining respective scores for the execution paths; selecting execution paths having scores above a threshold; determining computer code parameters and hardware performance data associated with the selected execution paths; and fusing the determined computer code parameters and hardware performance data to form a kernel for inputting to a trained model.

In accordance with further embodiments, the selected execution paths are associated with respective sequences of functions.

In accordance with further embodiments, tracking the symbols includes determining at least one of a number of calls or a standard deviation associated with each of the symbols.

In accordance with further embodiments, the respective scores are based on runtimes associated with the execution paths.

Some disclosed embodiments describe non-transitory computer-readable media, systems, and methods for training a model to predict anomalous computing environment behavior. For example, in an exemplary embodiment, a method may include generating model training data comprising a plurality of reference data patterns associated with non-anomalous behavior by fusing sets of computer code parameters with respective hardware performance datasets; inputting the model training data to a model to prompt the model to generate a model training output; receiving the model training output from the model; and updating the model based on the model training output, thereby training the model to detect execution performance anomalies inconsistent with at least one of the reference data patterns.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 illustrates an exemplary pictographic representation of a network architecture for providing analysis and modeling benefits to devices, consistent with embodiments of the present disclosure.

FIG. 2 illustrates an exemplary pictographic representation of a modeler system, consistent with embodiments of the present disclosure.

FIG. 3 illustrates an exemplary pictographic representation of a computing device, consistent with embodiments of the present disclosure.

FIG. 4 illustrates an exemplary pictographic representation of a layered model architecture, consistent with embodiments of the present disclosure.

FIG. 5 illustrates an exemplary pictographic representation of a software-hardware fusion environment, consistent with embodiments of the present disclosure.

FIG. 6 depicts a flowchart of an exemplary process for training a model to predict anomalous computing environment behavior, consistent with embodiments of the present disclosure.

FIG. 7 depicts a flowchart of an exemplary process for fusing hardware and software information to form a kernel, consistent with embodiments of the present disclosure.

FIG. 8 depicts a flowchart of an exemplary process for using a kernel with a model to obtain model detection output, consistent with embodiments of the present disclosure.

### DETAILED DESCRIPTION OF EXEMPLARY EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

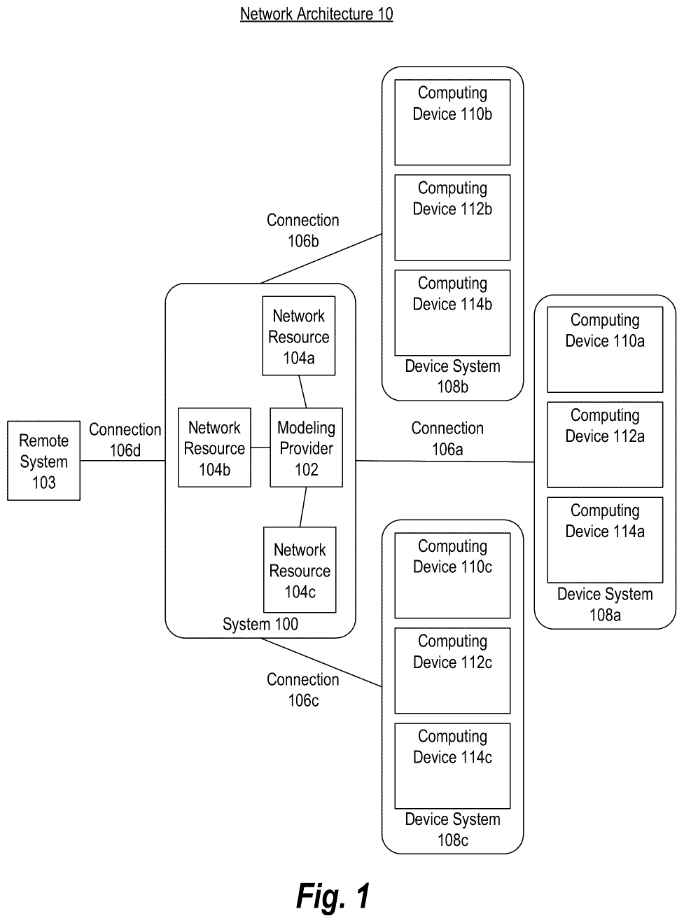

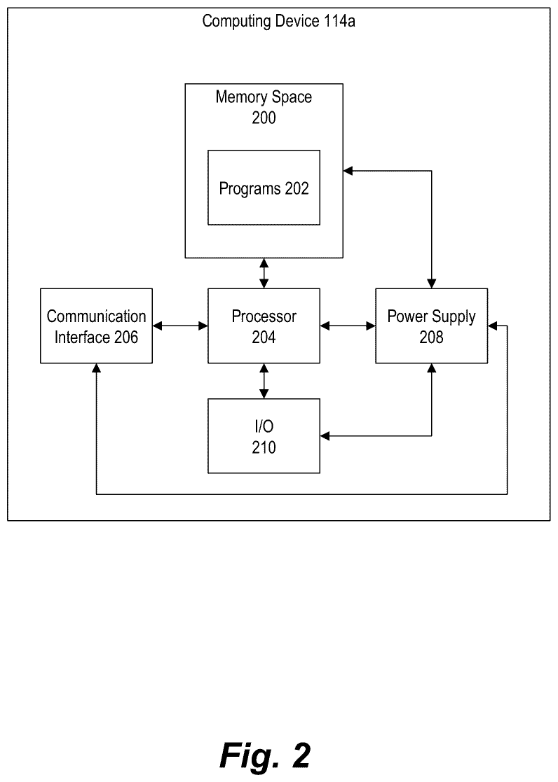

FIG. 1 illustrates an exemplary pictographic representation of network architecture 10, which may include a system 100. System 100 may be maintained, for example, by an artificial intelligence (AI) analysis provider, a security provider, software developer, an entity associated with developing or improving computer software, or any combination of these entities. System 100 may include a modeling provider 102, which may be a single device or combination of devices and is described in further detail with respect to FIG. 2. Modeling provider 102 may be in communication with any number of network resources, such as network resources 104a, 104b, and/or 104c. A network resource may be a database, supercomputer, general purpose computer, special purpose computer, virtual computing resource (e.g., a virtual machine or a container), graphics processing unit (GPU), or any other data storage or processing resource.

Network architecture 10 may also include any number of device systems, such as device systems 108a, 108b, and 108c. A device system may be, for example, a computer system, a home security system, a parking garage sensor system, a vehicle, an inventory monitoring system, a connected appliance, telephony equipment, a network routing device, a smart power grid system, a drone or other unmanned vehicle, a hospital monitoring system, any Internet of Things (IoT) system, or any arrangement of one or more computing devices. A device system may include devices arranged in a local area network (LAN), a wide area network (WAN), or any other communications network arrangement. Further, each controller system may include any number of devices, such as controllers. For example, exemplary device system 108a includes computing devices 110a, 112a, and 114a, one or more of which may be IoT devices (e.g., controllers), which may have the same or different functionalities or purposes. These devices are discussed further through the description of exemplary computing device 114a, discussed with respect to FIG. 2. Device systems 108a, 108b, and 108c may connect to system 100 through connections 106a, 106b, and 106c, respectively. System 100 may also connect through connection 106d to a remote system 103, which may include any number of computing devices (e.g., one or more servers, personal desktop computers, computing machines). Remote system 103 may be associated with a creator of code, a manufacturer of a physical component and/or device (e.g., controller), a system (e.g., vehicle) manufacturer, or another entity associated with developing and/or deploying software. In some embodiments, remote system 103 may also connect to a device system (e.g., device system 108a), such as through a connection separate from connection 106d. In some embodiments, system 100 may provide digital information to remote system 103 based on operations performed by system 100 (e.g., as discussed with respect to the figures below). A connection 106 (exemplified by connections 106a, 106b, 106c, and 106d) may be a communication channel, which may include a bus, a cable, a wireless (e.g., over-the-air) communication channel, a radio-based communication channel, a local area network (LAN), the Internet, a wireless local area network (WLAN), a wide area network (WAN), a cellular communication network, or any Internet Protocol (IP) based communication network and the like. Connections 106a, 106b, 106c, and 106d may be of the same type or of different types, and may include combinations of types (e.g., the Internet and a LAN).

Any combination of components of network architecture 10 may perform any number of steps of the exemplary processes discussed herein, consistent with the disclosed exemplary embodiments.

FIG. 2 illustrates an exemplary pictographic representation of computing device 114a, which may be a computer, a server, an IoT device, or a controller, etc. For example, computing device 114a may be an automotive controller, such as an electronic control unit (ECU) (e.g., manufactured by companies such as Bosch™, Delphi Electronics™, Continental™, Denso™, etc.), or may be a non-automotive controller, such as an IoT controller manufactured by Skyworks™, Qorvo™, Qualcomm™, NXP Semiconductors™, etc. Further, computing device 114a may be an IoT controller, such as those manufactured by ASRock™, National Control Devices™ Intel™, Denso™, Optex™, and various others. Computing device 114a may be configured (e.g., through software program(s) 202) to perform a single function (e.g., a braking function in a vehicle), or multiple functions. Computing device 114a may perform any number of steps of the exemplary processes discussed herein, consistent with the disclosed exemplary embodiments.

Computing device 114a may include a memory space 200 and at least one processor 204. Memory space 200 may include a single memory component, or multiple memory components. Such memory components may include an electronic storage device, a magnetic storage device, an optical storage device, an electromagnetic storage device, a semiconductor storage device, etc., or any suitable combination of the foregoing. For example, memory space 200 may include any number of hard disks, random access memories (RAMs), read-only memories (ROMs), erasable programmable read-only memories (EPROMs or Flash memories), and the like. Memory space 200 may include one or more storage devices configured to store instructions usable by processor 204 to perform functions related to the disclosed embodiments. For example, memory space 200 may be configured with one or more software instructions, such as software program(s) 202 or code segments that perform one or more operations when executed by processor 204 (e.g., the operations discussed in connection with figures below). The disclosed embodiments are not limited to separate programs or computers configured to perform dedicated tasks. For example, memory space 200 may include a single program or multiple programs that perform the functions associated with network architecture 10. Memory space 200 may also store data that is used by one or more software programs (e.g., data relating to controller functions, data obtained during operation of the vehicle, or other data).

In certain embodiments, memory space 200 may store software executable by processor 204 to perform one or more methods, such as the methods discussed below. The software may be implemented via a variety of programming techniques and languages, such as C or MISRA-C, ASCET, Simulink, Stateflow, and various others. Further, it should be emphasized that techniques disclosed herein are not limited to automotive embodiments. Various other IoT environments may use the disclosed techniques, such as smart home appliances, network security or surveillance equipment, smart utility meters, connected sensor devices, parking garage sensors, and many more. In such embodiments, memory space 200 may store software based on a variety of programming techniques and languages such as C, C+, C++, C#, PHP, Java, JavaScript, Python, and various others.

Processor 204 may include one or more dedicated processing units, application-specific integrated circuits (ASICs), field-programmable gate arrays (FPGAs), graphical processing units, or various other types of processors or processing units coupled with memory space 200.

Computing device 114a may also include a communication interface 206, which may allow for remote devices to interact with computing device 114a. Communication interface 206 may include an antenna or wired connection to allow for communication to or from computing device 114a. For example, an external device (such as computing device 114b, computing device 116a, modeling provider 102, or any other device capable of communicating with computing device 114a) may send code to computing device 114a instructing computing device 114a to perform certain operations, such as changing software stored in memory space 200.

Computing device 114a may also include power supply 208, which may be an AC/DC converter, DC/DC converter, regulator, or battery internal to a physical housing of computing device 114a, and which may provide electrical power to computing device 114a to allow its components to function. In some embodiments, a power supply 208 may exist external to a physical housing of a computing device (i.e., may not be included as part of computing device 114a itself), and may supply electrical power to multiple computing devices (e.g., all controllers within a controller system, such as a device system 108a).

Computing device 114a may also include input/output device (I/O) 210, which may be configured to allow for a user or device to interact with computing device 114a. For example, I/O 210 may include at least one of wired and/or wireless network cards/chip sets (e.g., WiFi-based, cellular based, etc.), an antenna, a display (e.g., graphical display, textual display, etc.), an LED, a router, a touchscreen, a keyboard, a microphone, a speaker, a haptic device, a camera, a button, a dial, a switch, a knob, a transceiver, an input device, an output device, or another I/O device configured to perform, or to allow a user to perform, any number of steps of the methods of the disclosed embodiments, as discussed further below. While FIG. 2 depicts exemplary computing device 114a, these described aspects of computing device 114a (or any combination thereof) may be equally applicable to any other device in the network architecture, such as computing device 110b, computing device 110c, modeling provider 102, or network resource 104a. For example, any other device in the network architecture may include any combination of the same components and functionalities as exemplary computing device 114a.

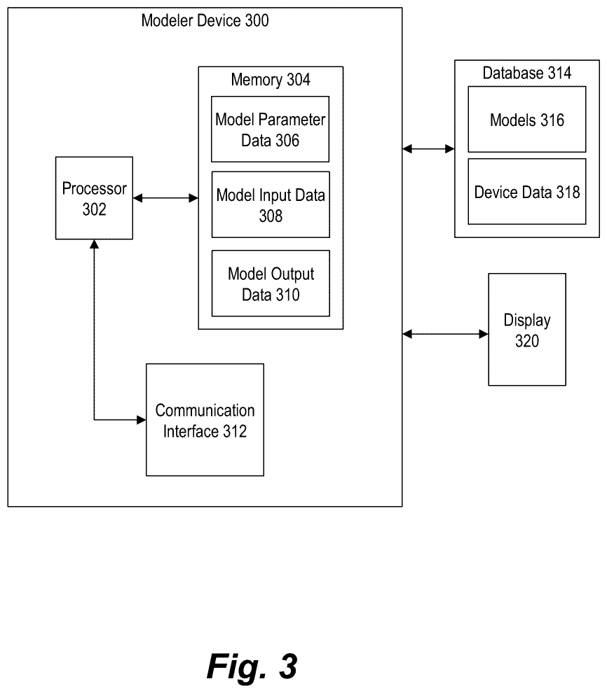

FIG. 3 illustrates an exemplary pictographic representation of modeling provider 102, which may be a single device or multiple devices. In the embodiment shown, modeling provider 102 includes a modeler device 300, which may be a computer, server, mobile device, special purpose computer, or any other computing device that may allow a user to perform any number of steps of the methods of the disclosed embodiments, as discussed further below. For example, modeler device 300 may include a processor 302, which may be configured to execute instructions stored at memory 304. Memory 304 may include multiple memory components (e.g., a hard drive, a solid-state drive, flash memory, random access memory) and/or partitions. Memory 304 may also store data (e.g., instructions) to be used in methods of the disclosed embodiments, as discussed further below.

Memory 304 may include one or more datasets, which may be used to, for example, initialize, train, configure, update, reconfigure, and/or run a model (e.g., a machine learning model). For example, memory 304 may include model parameter data 306, which may include one or more parameters (e.g., hyperparameters, seed values, initialization parameters, node configurations, layer configurations, weight values, tokens, etc.) that may be usable to influence the configuration of a model. Memory 304 may also include model input data 308, which may include one or more data elements (e.g., kernels, values, vectors, matrices, strings, tokens, etc.) that may be configured to input to a model. Model input data 308 may include and/or be based upon programming code element, consistent with embodiments discussed herein. Memory 304 may also include model output data 310, which may include data output from a model (e.g., one or more values, vectors, matrices, strings, and/or probabilities). For example, model output data 310 may include a predictive value representing a probability of digital information being true and/or a probability amount (e.g., a highest probability amount) or multiple probabilities (e.g., a probability associated with digital information predicted to achieve increasing or maximization of a metric). As another example, model output data 310 may include a predictive value representing a likelihood (e.g., probability) of a particular software and/or hardware issue, and/or a cause of the issue, consistent with disclosed embodiments.

In some embodiments, modeler device 300 may connect to a communication interface 312, which may be similar to communication interface 206 and/or I/O 210, described above. For example, communication interface 312 may include at least one of wired and/or wireless network cards/chip sets (e.g., WiFi-based, cellular based, etc.), an antenna, a display (e.g., graphical display, textual display, etc.), an LED, a router, a touchscreen, a keyboard, a mouse, a microphone, a speaker, a haptic device, a camera, a button, a dial, a switch, a knob, a transceiver, an input device, an output device, or another device configured to perform, or to allow a user to perform, any number of steps of the methods of the disclosed embodiments, as discussed further below. Communication interface 312 may also allow modeler device 300 to connect to other devices, such as other devices within modeling provider 102, other devices within a system 100, and/or devices external to system 100, such as a computing device 114a. In some embodiments, communication interface 312 (e.g., a network adapter, an ethernet interface, an antenna, etc.) may connect with database 314, which may also be connectable to a device other than modeler device 300 (e.g., a device external to system 100), to communicate with database 314.

Modeler device 300 may also connect to database 314, which may be an instance of a network resource, such as network resource 104a. Database 314 may store data to be used in methods of the disclosed embodiments, as discussed further below. For example, database 314 may maintain any number of models 316, which may be fully trained, partially trained, or untrained. Models 316 may be associated with respective specific input data, devices, and/or entities, consistent with the disclosed embodiments. Models 316 may include one or more of a statistical model, a regression model (e.g., one or more regression layers), a stochastic model, a probabilistic model, a language model, an encoder-decoder model, a transformer model, a neural network (e.g., one or more neural network layers, a deep neural network (DNN), a recurrent neural network, also called an RNN, a convolutional neural network, also call a CNN), a random forest, a generative adversarial network (GAN), a support-vector machine (SVM), a bag-of-words model, a Word2Vec model, a sequence-to-sequence model, a learning model, a predictive model or any other AI-based digital tool. Additionally or alternatively, a model may include at least one encoder and at least one decoder, for example in an encoder-decoder structure. It is appreciated that the human mind is not equipped to perform the operations for which model 316 is configured, given its arrangement and combination of model elements (e.g., nodes, layers, parameters, connections), as further demonstrated in model architecture 400, as well as its ability to process inputs not practically understandable to the human mind (e.g., compiled code). A model 316 may include a code language processing model (e.g., a large code language model, or LCLM), or any other model discussed herein.

Database 314 may include any number of disk drives, servers, server arrays, server blades, memories, or any other medium capable of storing data. Database 314 may be configured in a number of fashions, including as a textual database, a centralized database, a distributed database, a hierarchical database, a relational database (e.g., SQL), an object-oriented database, or in any other configuration suitable for storing data. While database 314 is shown externally to modeling provider 102 (e.g., existing at a remote cloud computing platform, for example), it may also exist internally to it (e.g., as part of memory 304).

In some embodiments, database 314 may include device data 318, which may include operational data (e.g., log data) and/or program data (e.g., compiled code, uncompiled code, an executable program, an application) associated with one or more devices. In some embodiments, device data 318 may be in a format that is unrecognizable to a model, and may be converted to a format, arrangement, or representation that a model is configured to receive as input (e.g., model input data 308), which may bear no resemblance to the initial format and may not be understandable to a human.

Modeler device 300 may also be communicably connectable with a display 320, which may include a liquid crystal display (LCD), in-plane switching liquid crystal display (IPS-LCD), light-emitting diode (LED) display, organic light-emitting diode (OLED) display, active-matrix organic light-emitting diode (AMOLED) display, cathode ray tube (CRT) display, plasma display panel (PDP), digital light processing (DLP) display, or any other display capable of connecting to a user device and depicting information to a user. Display 320 may display graphical interfaces, interactable graphical elements, animations, dynamic graphical elements, and any other visual element, such as visual elements indicating digital information associated with a model (e.g., associated with training a model or model output), among others.

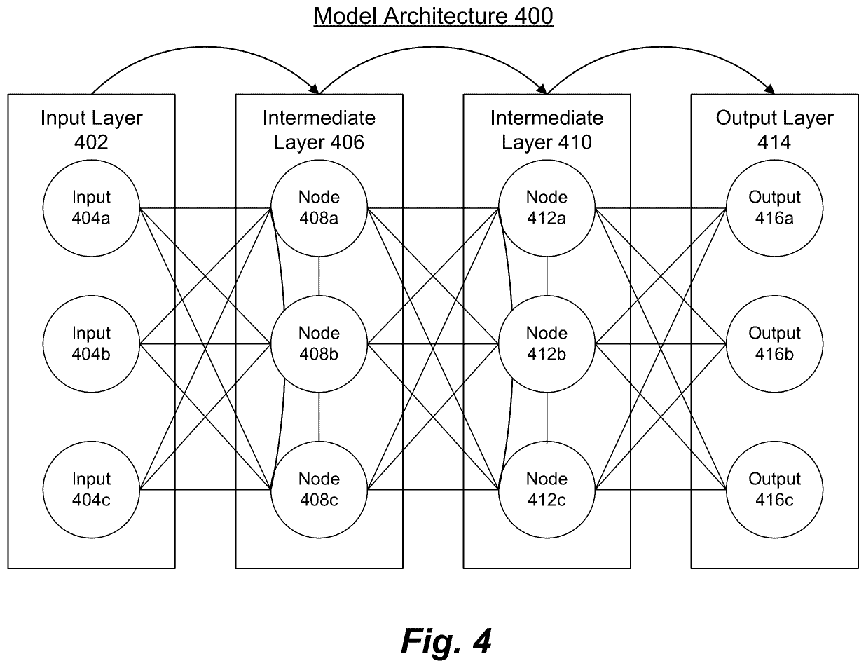

FIG. 4 illustrates an exemplary pictographic representation of a model architecture 400. Model architecture 400 may represent a structure for a model (e.g., a model 316, which may be an AI model), though many variations are possible, which may or may not include elements shown in FIG. 4. Model architecture 400 may include a number of model layers, which may be organized in a sequence or other arrangement, such as within a neural network or other machine learning model. A model layer may be, for example, a regression layer, a convolution layer, a deconvolution layer, a fully connected layer, a partially connected layer, a recurrent layer, a pooling layer, an activation layer, a sequence layer, a normalization layer, a resizing layer, a pooling layer, an unpooling layer, or a dropout layer. For example, model architecture 400 may include an input layer 402, which may include and/or be configured to receive one or more model inputs, such as input 404a, input 404b, and input 404c (which may be considered nodes), consistent with disclosed embodiments. Of course, other numbers or configurations of input layers and inputs are possible.

Model architecture 400 may also include one or more intermediate layers, such as intermediate layer 406 and intermediate layer 410. An intermediate layer may include one or more nodes (e.g., model neurons), which may be connected (e.g., artificially neurally connected) to another node, layer, input, and/or output. For example, intermediate layer 406 may include nodes 408a, 408b, and 408c, which are shown with exemplary connections to input 404a, input 404b, input 404c, as well as to nodes included in intermediate layer 410—node 412a, node 412b, and node 412c. Of course, other numbers or configurations of intermediate layers and nodes are possible.

Model architecture 400 may also include an output layer 414, which may include one or more outputs and/or be configured to generate one or more model outputs, such as output 416a, output 416b, and output 416c (which may be considered nodes). One or more of the outputs may include or represent analysis of programming code, a prediction associated with programming code, or any other modeled aspect of programming code, consistent with disclosed embodiments. As depicted in FIG. 4, inputs to a layered architecture may be influenced by a complex interconnected web of connections between nodes. In some embodiments, the connections may represent unidirectional relationships, bidirectional relationships, dependent relationships, interdependent relationships, correlative relationships, or any combination thereof. In some embodiments, one or more nodes may be activated or deactivated, which may be dependent on initialization parameters and/or training parameters of a model. A training parameter may include, for example, a number of nodes, a configuration of nodes, types of nodes within the configuration, a number of layers, a configuration of layers, types of nodes within the layers, a number of training epochs, a sequence of training operations, or any other digital information that can influence the performance of training a model. In some embodiments, different nodes (or other model parameters) may be associated with different weights (which may also be considered a model parameter). Model architecture 400 may operate according to (e.g., using) one or more algorithms, such as a backpropagation algorithm, a gradient descent algorithm, loss function, regression function, or any AI-related algorithm. The exemplary processes described below may be carried out using a model including any or all aspects of model architecture 400. Nodes and layers may be considered model parameters. As shown in FIG. 4, different nodes in different layers, or the same layer, may be connected in a number of different ways. The connections shown are exemplary, and fewer or additional connections may exist.

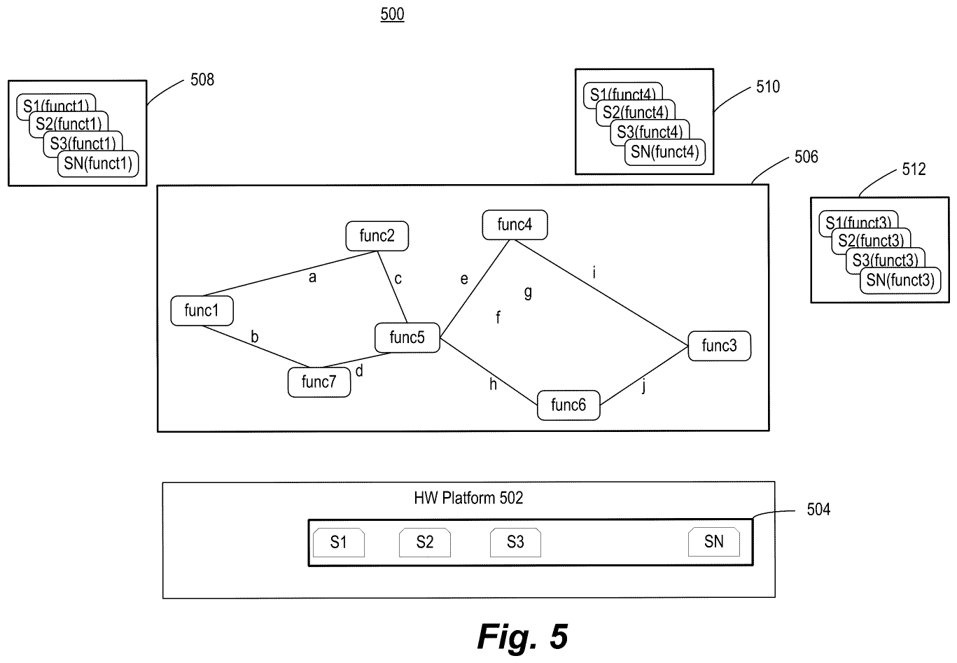

FIG. 5 illustrates an exemplary pictographic representation of a software-hardware fusion environment 500, consistent with disclosed embodiments. Software-hardware fusion environment 500 may include a hardware (HW) platform 502, which may be part of, or communicably coupled to, a system 100, device system 108a, device system 108b, device system 108b, and/or any other system discussed herein. For example, HW platform 502 may be part of, or communicably coupled to, a system that includes one or more controllers. HW platform 502 may include one or more sensors 504 (e.g., power sensors, temperature sensors, accelerometers, gyroscopes, etc.), such as exemplary sensors S1, S2, and S3, up to SN. In some embodiments, one or more of sensors 504 may be configured to detect information (e.g., measure values) associated with one or more devices (e.g., controllers), consistent with disclosed embodiments. Sensors 504 may be configured to detect and/or record information at inhuman rates, such as 60 Hz or higher. Sensors 504 also be configured to record information at local memory and/or transmit information written to local memory to other devices or systems, such as system 100 or remote system 103 (e.g., for fusing with hardware data, further, analysis, modeling, processing with a model, etc.).

Software-hardware fusion environment 500 may also include code present on one or more controllers (e.g., configured to execute on one or more controllers, installed on one or more controllers). This code may be represented or modeled by software model 506, which may include, store, and/or represent software symbols, which may include or represent one or more of at least one function, at least one execution path, at least one variable, at least one buffer, at least one call, at least one process, at least one object, at least one memory location, at least one memory value, at least one segment (e.g., line) of code, a controller to which the symbol relates, a system to which the symbol relates, or at least one resource usage associated with any of the aforementioned symbols (e.g., associated with execution of one or more functions). For example, as depicted in FIG. 5, software model 506 includes seven functions (func1, func2, func3, func4, func5, func6, and func7) and execution paths between the functions (a, b, c, d, e, f, g, h, i, and j). Software model 506 may be stored at, for example, one or more of database 314, modeler device 300, system 100, remote system 103, or a device system. In some embodiments, the code represented by or modeled by software model 506 may be stored at one device, such as modeling provider 102, but the code itself may be present on (e.g., configured to execute on) a different device, such as device system 108a.

In some embodiments, one or more of sensors 504 may be configured to detect information associated with the code represented or modeled by software model 506. For example, one or more of sensors 504 may measure a particular type of information associated with the code. In some embodiments, one or more of sensors 504 may measure information while at least a portion of the code (e.g., func1) is running (e.g., executed). As depicted in FIG. 5, one or more of sensors 504 may output one or more measured sensor values, which may be associated with a particular portion of the code (e.g., a portion of code executed while the values were measured). These measured sensor values may be consolidated into respective datasets, such as dataset 508, dataset 510, and dataset 512. In some embodiments, each dataset may be associated with a particular portion of code (e.g., function). For example, as depicted in FIG. 5, dataset 508 is associated with func1, dataset 510 is associated with func4, and dataset 512 is associated with func3. It is appreciated that the numbers of functions, paths, sensors, etc. in FIG. 5 is exemplary, and that in many embodiments there may exist, dozens, hundreds, or even thousands of symbols, sensor values, and the like, which would be impractical if not impossible to comprehend simultaneously by the human mind.

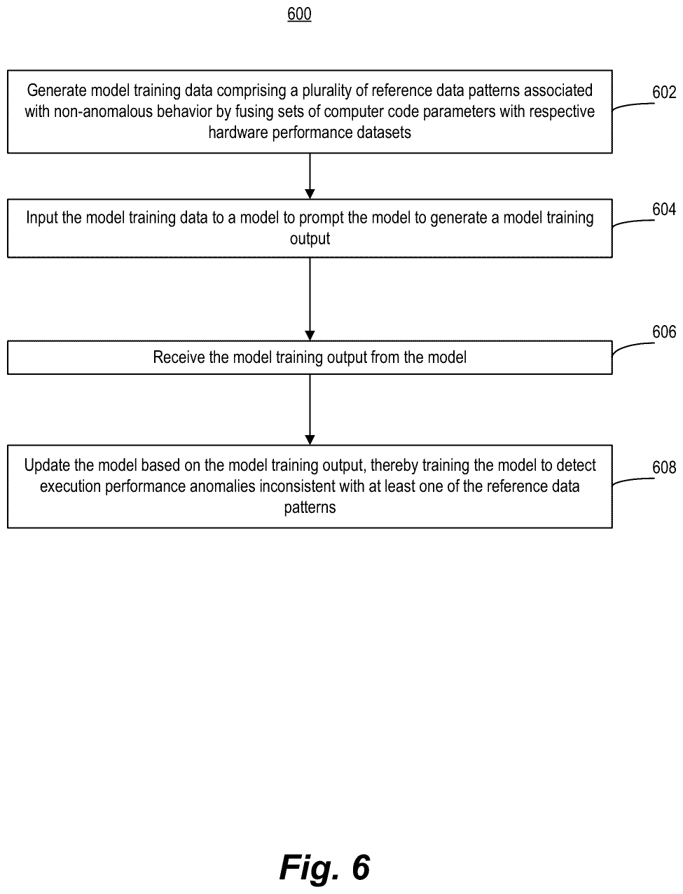

FIG. 6 shows an exemplary process 600 for training a model to predict anomalous computing environment behavior. In accordance with disclosed embodiments, process 600 may be implemented in system 100 depicted in FIG. 1, or any type of network environment. For example, process 600 may be performed by at least one processor (e.g., processor 302), memory (e.g., memory 304), and/or other components of modeling provider 102 (e.g., components of one or more modeler devices 300), or by any computing device or IoT system. All or part of process 600 may be implemented in conjunction with all or part of other processes discussed herein (e.g., process 700 and/or process 800). For example, a model trained or updated using process 600 may be used in process 800. Additionally, as another example, input data for an untrained model in process 600 may share characteristics with input data for a trained model in process 800, or may be manipulated or generated according to process 700.

At step 602, process 600 may generate model training data. Model training data may include digital information relating to computer code (e.g., compiled, uncompiled, executed, unexecuted, executable, and/or inexecutable), such as computer code parameters, and/or device or component behavior. Computer code may be compiled (e.g., binary code, which may be configured for execution on a controller) or uncompiled (e.g., interpreter-based code). Computer code may include one or more software symbols, discussed above. Additionally or alternatively, computer code may include, represent, or be associated with computer code parameters. The computer code parameters may include at least one of one or more instruction cycles, one or more branch jumps, memory usage, an amount of time (e.g., time of code execution), or any software symbol. In some embodiments, the model training data and/or computer code may be associated with at least one device. For example, the computer code may be configured to execute on at least one device (e.g., a particular type and/or model of device, such as a particular controller).

In some embodiments, generating the model training data may include labeling or otherwise associating the fused sets with particular operational behavior (e.g., expected behavior, anomalous behavior, behavior of a particular device, hazardous behavior, and/or risky behavior). In some embodiments, some model training data may be labeled and other model training data (e.g., validation data) may not.

Additionally or alternatively, model training data may include digital tags or other information indicating a data type (e.g., normal execution or operational behavior by at least one device, erroneous execution or operational behavior by at least one device, non-anomalous execution or operational behavior by at least one device, anomalous execution or operational behavior by at least one device, statistically significant execution or operational behavior by at least one device, and/or execution or operational behavior by at least one device in a particular operational state).

In some embodiments, the model training data may comprise a plurality of reference data patterns associated with non-anomalous behavior. A reference data pattern may include a representation of expected or desired operation of at least one device. For example, a reference data pattern may include a sequence or correlation of sequences of functions, calls, memory locations, objects, sensor measurements, any amount of computer code, and/or any digital indicator of device performance or execution. For example, a reference data pattern may include a matrix of values, strings, or other digital information associated with at least one device, which may include a sequence or correlated sequences. In some embodiments, a row or column of the matrix may be associated with (e.g., may indicate, may be correlated with, and/or may be based on) a time or a computer code element. A location within a matrix may be associated with (e.g., may indicate, may be correlated with, and/or may be based on) a hardware performance value or dataset, consistent with disclosed embodiments. Additionally or alternatively, the reference data patterns may correspond to or represent actual prior operation of at least one device.

In some embodiments, generating model training data may include accessing (e.g., receiving, requesting, downloading, and/or verifying) computer code (e.g., computer code parameters) and/or hardware performance datasets. Computer code and/or hardware performance datasets may be accessed from at least one local device and/or at least one remote device (e.g., a controller in a remote system). In some embodiments, process 600 may generate model training data at least in part by fusing sets of computer code parameters with respective hardware performance datasets. Fusing sets of computer code parameters with respective hardware performance datasets may include associating, joining, placing within a common data structure, structuring within a matrix, and/or connecting computer code parameters with hardware performance data. For example, fusing sets of computer code parameters with respective hardware performance datasets may include correlating computer code parameters with hardware performance data according to time (e.g., represented by one or more timestamps). Computer code parameters may include at least one of execution timing, execution sequences, functions, calls, objects, variables, processes, memory locations, memory values, or any indication of how code may be executed by at least one device. Hardware performance data may include one or more values indicating a trait of a hardware element associated with a particular time and/or particular computer code. For example, hardware performance data may include at least one value measured by a sensor. The at least one value may be based on functioning (e.g., operation, execution of the computer code) of at least one device based on the computer code. For example, the at least one value may include a voltage value, a current value, a power value, a heat value, a temperature value, a pressure value, an acceleration value, a motion value, a light value, a communication interface usage value, or any other value of a measurement of a trait of the at least one device. In some embodiments, hardware performance data may include values derived from information detected, sensed, and/or recorded by hardware. For example, values derived from hardware performance data may be derived through transformation of the captured information through a function and/or a model, and/or scaling of the data.

In some embodiments, model training data may only include a subset of potentially available computer code, computer code parameters, or hardware performance data. A subset may be determined or selected (e.g., by the model, by another model, by a computer, etc.) based on measurement and/or processing capabilities of a device (e.g., device associated with the computer code) or sensor. A subset may also be determined based on a rank or priority of computer code. For example, process 600 may determine ranks for functions or other software symbols within the computer code, which may be calculated based on a graphed ranked algorithm or other algorithm, which may use variables such as one or more of time to execute, memory usage, cycle values, and/or any statistical values thereof.

In some embodiments, the hardware performance data may be based on a first hardware performance measurement (e.g., measurement of a hardware trait, which may be measured by a sensor) determined when a first portion of the computer code (e.g., at least one function, at least one variable, at least one variable access, at least one function branch, at least one branch point (e.g., division point), or any combination of these or other software symbols) associated with one of the two distinct execution points is executed and a second hardware performance measurement determined when a second portion of the computer code associated with the other of the two distinct execution points is executed. The hardware performance data may be based on (e.g., may include) a difference between the first hardware performance measurement and the second hardware performance measurement, such as the deltas between measurements associated with different portions and/or sequences of computer code (e.g., S1(funct1)-S1(func3), shown in FIG. 5). Additionally or alternatively, the hardware performance data may include at least one hardware performance measurement determined when a portion of the computer code (e.g., a third function) is executed between the two distinct execution points (e.g., first and second functions). Deltas may be represented in a number of forms, including not only individual measurement-deltas, as described above, but also sample deltas, matrix deltas, kernel deltas, statistical deltas, and/or the like. In some embodiments, deltas, or information indicating deltas (e.g., pairs of matrices associated with different samples) may be included in the model training data. In some embodiments, model training data may include random samples of computer code and/or hardware performance data, which may provide a more accurate picture of typical device behavior to a model.

At step 604, process 600 may input the model training data to a model to prompt the model to generate a model training output. The model may include an artificial intelligence (AI) model, such as a machine learning model, a statistical model, a neural network model (e.g., a perceptron, or a convolutional neural network or CNN), a random forest, a generative adversarial network (GAN), a regression model, a transformer model (e.g., ROBERTa), or any learning and/or predictive model. For example, the model may use a form of model architecture 400. In some embodiments, the model may be a DNN, and may include 500 or more, 1,000 or more, or 10,000 or more branches. In some embodiments, the model may be trained using, and/or may include (e.g., as a trained or untrained model), variational autoencoders, which may allow, at least in some embodiments, for faster training on a chip (e.g., processor) and for easier deployment to a chip. In some embodiments, a model's complexity (e.g., total size, number of nodes, number of layers, processing resource demand, etc.) may be limited based on hardware capabilities (e.g., for training the model and/or running a trained model), such as the layer support of a chip.

In some embodiments, the model may generate the model training output based on (e.g., using, in response to) the model training data. For example, process 600 may input the model training input data to an input layer of the model, which may prompt the model to execute a combination of operations between nodes of the model, which may produce the model training output, which may not resemble the input. In some embodiments, the model training output may include an indication or prediction associated with the training data input to the model. For example, the model training output may include a prediction (e.g., predicted classification, predicted amount of anomalous behavior) associated with the training input data. Additionally or alternatively, the model training output may include a confidence score associated with the prediction and/or identifications of parts of computer code associated with anomalous behavior. For example, the model training output may include a prediction of whether at least a portion of the model training input (e.g., computer code) is associated with (e.g., correlated with, likely to have caused, etc.) anomalous device behavior.

At step 606, process 600 may receive the model training output from the model. Receiving the model training output may include accessing the model training output, requesting the model training output, and/or storing the model training output. The model training output may be received across a local area and/or wide area communication connection, consistent with disclosed embodiments. In some embodiments, one device implementing process 600 may receive the model training output and may transmit it to another device (e.g., a device that requested training or updating of the model), which may be part of a LAN or a WAN.

In some embodiments, process 600 may verify, validate, and/or assess the model training output. For example, process 600 may compare the model training output to model validation data, which may be similar to (e.g., associated with the same device or type of device) and/or received with the model training input, but may have been withheld from training (e.g., not used as input to the model).

At step 608, process 600 may update the model based on the model training output. This may thereby train the model to detect execution performance anomalies inconsistent with at least one of the reference data patterns, which are often impractical if not impossible for a human to detect, given the large amounts of computerized data that such anomalies exist within. Updating the model may include changing one or more model parameters, such as adding, removing, rearranging, moving, or modifying at least one of a model node, a model layer, a seed value, a model weight, hyperparameter, a model bias, a model neuron, a layer connection, a node connection, or any digital value contributing to defining the structure and/or functioning of the model. In some embodiments, one or more devices implementing process 600 may implement one or more of its steps repeatedly, which may further enhance the performance abilities of the updated or trained model. In some embodiments, process 600 (or any other process described herein) may update (e.g., automatically) the model based on (e.g., in response to) changes to computer code, for example based on changes made to binary code (e.g., a binary code file representing or including the computer code).

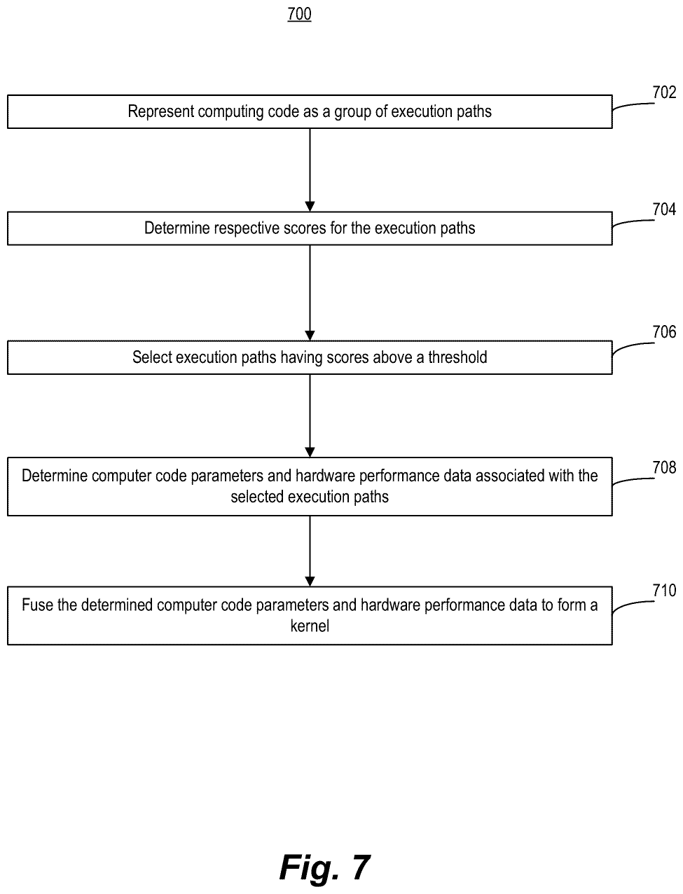

FIG. 7 shows an exemplary process 700 for fusing hardware and

software information. In accordance with disclosed embodiments, process 700 may be implemented in system 100 depicted in FIG. 1, or any type of network environment. For example, process 700 may be performed by at least one processor (e.g., processor 302), memory (e.g., memory 304), and/or other components of modeling provider 102 (e.g., components of one or more modeler devices 300), or by any computing device or IoT system. All or part of process 700 may be implemented in conjunction with all or part of other processes discussed herein (e.g., process 600 and/or process 800). For example, information fused by process 700 may be used to train a model (e.g., as input data) using process 600 and/or may be used as input to a trained model in process 800. Additionally, as another example, input data for an untrained model in process 600 or a trained model in process 800 may be manipulated or generated according to process 700.

At step 702, process 700 may represent computer code as a group of execution paths. A group of execution paths may include execution information (e.g., time of execution, operations executed) associated with (e.g., between) multiple symbols of the computer code. For example, the group of execution paths may include information associated with executing functions (or any combination of symbol types) in a particular order. For example, process 700 may generate a software model 506 representing the computer code. In some embodiments, representing the computer code as a group of execution paths may include collecting traces associated with the computer code (e.g., using tracepoints, discussed below); and tracking symbols representing portions of the computer code. Tracking the symbols may include monitoring, determining, and/or copying information associated with execution of the code underlying the symbols, whether through simulation, static analysis, and/or dynamic analysis. For example, tracking the symbols may include determining at least one of a number of calls and/or a standard deviation associated with each of the symbols.

At step 704, process 700 may determine respective scores for the execution paths. Determining the respective scores may include computing one or more values associated with one or more of the execution paths. In some embodiments, the respective scores may be based on (e.g., associated with, correlated with) one or more of computational intensity associated with the execution paths, resource usage associated with the execution paths, numbers of branches associated with the execution paths, configurations of branches associated with the execution paths, or runtimes associated with the execution paths. For example, in some embodiments, the respective scores may be based on runtimes associated with the execution paths (e.g., determined from simulation, static analysis, and/or dynamic analysis).

At step 706, process 700 may select execution paths having scores above a threshold. The threshold may be, for example, a fixed score value (e.g., a score of 8/10 or higher) or relative value (e.g., a score in the top 10% of scores, any score outside of a standard deviation of a mean or median). The selected execution paths may be associated with (e.g., may correspond to) respective sequences of functions or other symbols represented in or with the group of execution paths. By selecting a subset of available execution paths, this may reduce the amount of irrelevant data fed as training data to a model, while also improving the model's focus on computer code more likely to be associated with anomalous behavior.

At step 708, process 700 may determine computer code parameters and/or hardware performance data associated with the selected execution paths. Determining computer code parameters associated with the selected execution paths may include determining computer code parameters executed, used, or relied on as part of execution of at least one of the selected execution paths. Additionally or alternatively, determining hardware performance data associated with the selected execution paths may include determining hardware performance data generated, detected, recorded, stored, or realized based on (e.g., during actual or simulated execution of, or correlated with) at least one of the selected execution paths.

In some embodiments, execution paths, computer code (e.g., computer code parameters), and/or hardware performance data may be determined, tracked, analyzed, and/or stored based on tracepoints. For example, process 700 (or any other process described herein) may use tracepoints to determine when to determine a hardware-based measurement (e.g., sensor measurement), e.g., during code execution. In some embodiments, process 700 (or any other process described herein) may adjust (e.g., automatically) the tracepoints (e.g., remove tracepoints, add tracepoints, and/or shift locations of tracepoints) based on (e.g., in response to) changes to computer code, for example based on changes made to binary code (e.g., a binary code file representing or including the computer code). Additionally or alternatively, execution paths, computer code (e.g., computer code parameters), and/or hardware performance data may be determined, tracked, analyzed, and/or stored based on buffer triggers. For example, when a buffer associated with the computer code reaches a predetermined point, trace data collection may occur, such as according to a reading (e.g., of hardware performance information) scheduled for that point.

At step 710, process 700 may fuse the determined computer code parameters and hardware performance data. For example, process 700 may fuse the determined computer code parameters and hardware performance data to form a kernel for inputting to a trained model (e.g., configured as input for a trained model). A kernel may include at least one of a matrix, a vector, a kernel machine, a support-vector machine (SVM), or a data representation usable by an AI model. Additionally or alternatively, a kernel may include a function, which may be configured to transform data (e.g., computer code, computer code parameters, and/or hardware performance data, etc.) into a higher dimensionality space, which may be more suitable for processing by an AI model, and which may cause the underlying data to become invisible or non-understandable by human interpretation. Additionally or alternatively, a kernel may be encapsulated within a file and/or may include large amounts of information (e.g., a matrix with hundreds or thousands of rows or columns).

As described above, fusing sets of computer code parameters with respective hardware performance datasets may include correlating computer code parameters with hardware performance datasets according to time (e.g., represented by timestamps). For example, when a first amount of computer code is executed (or simulated or analyzed), such as a first function, process 700 (or any other process described herein) may determine a first time (e.g., generate a timestamp) and a first hardware performance value (e.g., a temperature), and may create a linkage (e.g., data association within a data structure, such as a matrix) between the non-exclusive three elements of this first group. Additionally, at a later point in time, when a second amount of computer code is executed (or simulated or analyzed), such as a second function, process 700 (or any other process described herein) may determine a second time (e.g., generate a second timestamp) and a second hardware performance value (e.g., a temperature), and may create a linkage (e.g., data association within a data structure, such as a matrix) between the non-exclusive three elements of this second group. In some embodiments, multiple linked groups may be included in a same data structure (e.g., kernel or matrix).

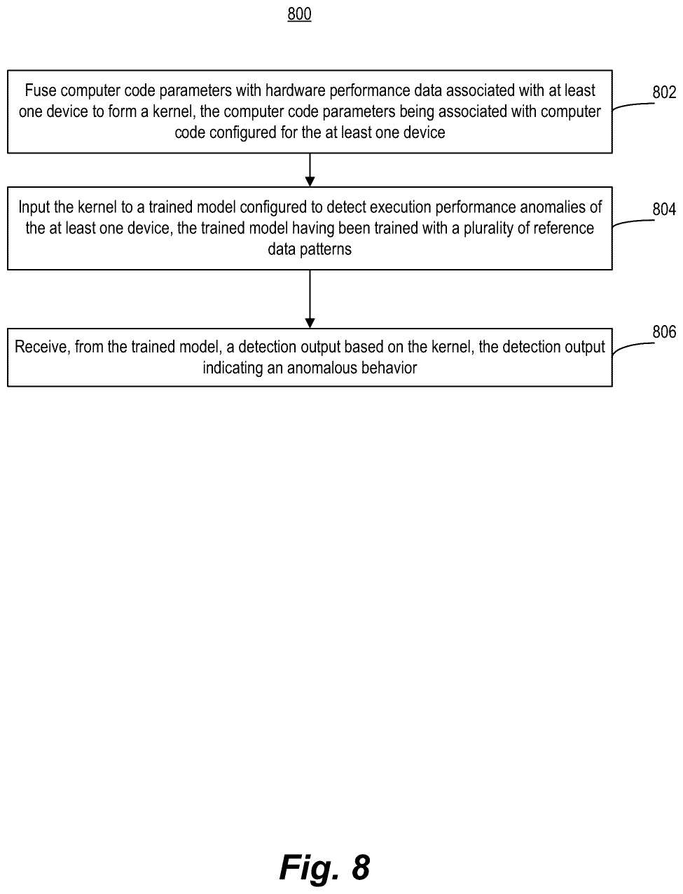

FIG. 8 shows an exemplary process 800 for detecting anomalous computing environment behavior. In accordance with disclosed embodiments, process 800 may be implemented in system 100 depicted in FIG. 1, or any type of network environment. For example, process 800 may be performed by at least one processor (e.g., processor 302), memory (e.g., memory 304), and/or other components of modeling provider 102 (e.g., components of one or more modeler devices 300), or by any computing device or IoT system. All or part of process 800 may be implemented in conjunction with all or part of other processes discussed herein (e.g., process 600 and/or process 700). For example, a model used in process 800 may have been trained or updated according to process 600, and input to a model used in process 800 may have been generated according to process 700.

At step 802, process 800 may fuse computer code parameters with hardware performance data, to form a kernel. As described above, a kernel may include at least one of a matrix, a vector, a function, or a data representation usable by an AI model.

In some embodiments, the computer code parameters and hardware performance data may be associated with at least one device (e.g., a controller). In some embodiments, the computer code parameters may be associated with (e.g., based on) computer code configured for the at least one device. In some embodiments, the computer code parameters may be included in the computer code. In some embodiments, the at least one device may include a virtual device (e.g., a device virtualized, simulated, or like). Additionally or alternatively, the at least one device may include a processor of a controller. Additionally or alternatively, the computer code may defined by at least two distinct execution points (e.g., two symbols within the computer code defining two points within an execution sequence). For example, the at least two distinct execution points may be represented by two distinct (e.g., different, separate) functions.

In some embodiments, the hardware performance data may be based on a first hardware performance measurement determined when a first portion of the computer code associated with one of the two distinct execution points is executed and a second hardware performance measurement determined when a second portion of the computer code associated with the other of the two distinct execution points is executed. Optionally, the hardware performance data may be based on a difference between the first hardware performance measurement and the second hardware performance measurement. In some embodiments, the hardware performance data may include at least one hardware performance measurement determined when a portion of the computer code is executed between the two distinct execution points.

In some embodiments, the hardware performance data may be associated with applying the computer code to the at least one device. For example, applying the computer code to the at least one device may include executing the computer code on the at least one device, and the hardware performance data may include measurements or other digital information determined (e.g., simultaneously) during, and/or correlated with, execution of the computer code. Additionally or alternatively, applying the computer code to the at least one device may include performing static or dynamic analysis of the computer code. Additionally or alternatively, applying the computer code to the at least one device may include determining how the at least one device will execute according to the computer code, such as in the context of the at least one device functioning within a system. For example, process 800 may include analyzing the at least one device with the computer code while accounting for functioning of the at least one device within the context of a system (e.g., a system including multiple controllers). By way of further example, a neural network or other AI model may receive execution information from one chip as model input and correlate that input with execution or hardware performance information from other devices (e.g., controllers).

In some embodiments, the hardware performance data may include at least one value measured by a sensor, and the at least one value may be based on functioning of the at least one device based on the computer code. In some embodiments, the at least one value may include at least one of a voltage value, a current value, a heat value, a light value, or a communication interface usage value, or any other value measured by a sensor, such as others discussed herein.

At step 804, process 800 may input the kernel to a trained model, which may be configured to detect execution performance anomalies of the at least one device. Additionally or alternatively, the trained model may have been trained with a plurality of reference data patterns, consistent with disclosed embodiments. In some embodiments, the trained model may detect at least one anomalous behavior based on the kernel. An anomalous behavior may include an execution performance anomaly associated with computer code, such as a statistically significant outlier of behavior (e.g., sensor measurements, code execution time, or any combination of execution and/or sensor activity). In some embodiments, the trained model may be configured to determine a prediction of an anomaly, which may include a probability associated with a detected (e.g., possible) execution performance anomaly.

At step 806, process 800 may receive, from the trained model, a detection output based on the kernel. In some embodiments, the detection output may indicate an anomalous behavior (e.g., detected at step 804). In other embodiments, the detection output may indicate non-anomalous behavior. Alternatively, the detection output may indicate a combination of indications of anomalous behavior (e.g., associated with first portions of computer code) and indications of non-anomalous behavior (e.g., associated with second portions of computer code). In some embodiments, the detection output may indicate a particular portion of the computer code precipitating the execution performance anomaly (e.g., predicted execution performance anomaly).

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways. Unless indicated otherwise, “based on” can include one or more of being dependent upon, being responsive to, being interdependent with, being influenced by, using information from, being derived from, resulting from, or having a relationship with.

For example, while some embodiments are discussed in a context involving a controller, this element need not be present in each embodiment, as other devices (e.g., embedded devices) may also operate within the disclosed embodiments. Such variations are fully within the scope and spirit of the described embodiments.

The disclosed embodiments may be implemented in a system, a method, and/or a computer program product. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Moreover, some blocks may be executed iteratively, and some blocks may not be executed at all. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of the terms is intended to include all such new technologies a priori.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A computer-implemented method for detecting anomalous computing environment behavior, comprising:
fusing computer code parameters with hardware performance data associated with at least one device to form a kernel, the computer code parameters being associated with computer code configured for the at least one device;
inputting the kernel to a trained model configured to detect execution performance anomalies of the at least one device, the trained model having been trained with a plurality of reference data patterns; and
receiving, from the trained model, a detection output based on the kernel, the detection output indicating an anomalous behavior.

2. The computer-implemented method of claim 1, wherein the trained model detects the anomalous behavior based on the kernel, the anomalous behavior including an execution performance anomaly associated with computer code.

3. The computer-implemented method of claim 2, wherein the detection output indicates a particular portion of the computer code precipitating the execution performance anomaly.

4. The computer-implemented method of claim 1, wherein the computer code is defined by at least two distinct execution points and the hardware performance data is associated with applying the computer code to the at least one device.

5. The computer-implemented method of claim 4, wherein the at least two distinct execution points are represented by two distinct functions.

6. The computer-implemented method of claim 4, wherein applying the computer code to the at least one device includes executing the computer code on the at least one device.

7. The computer-implemented method of claim 4, wherein the hardware performance data is based on a first hardware performance measurement determined when a first portion of the computer code associated with one of the two distinct execution points is executed and a second hardware performance measurement determined when a second portion of the computer code associated with the other of the two distinct execution points is executed.

8. The computer-implemented method of claim 7, wherein the hardware performance data is based on a difference between the first hardware performance measurement and the second hardware performance measurement.

9. The computer-implemented method of claim 4, wherein the hardware performance data includes at least one hardware performance measurement determined when a portion of the computer code is executed between the two distinct execution points.

10. The computer-implemented method of claim 1, wherein the hardware performance data includes at least one value measured by a sensor, the at least one value being based on functioning of the at least one device based on the computer code.

11. The computer-implemented method of claim 10, wherein the at least one value includes a voltage value, a current value, a heat value, a light value, or a communication interface usage value.

12. The computer-implemented method of claim 1, wherein the computer code parameters include at least one of one or more instruction cycles, one or more branch jumps, memory usage, or an amount of time.

13. The computer-implemented method of claim 1, wherein the at least one device comprises a virtual device.

14. The computer-implemented method of claim 1, wherein the at least one device comprises a processor of a controller.

15. A computer-implemented method for generating a kernel for a model, comprising:
representing computer code as a group of execution paths by:
collecting traces associated with the computer code; and
tracking symbols representing portions of the computer code;
determining respective scores for the execution paths;
selecting execution paths having scores above a threshold;
determining computer code parameters and hardware performance data associated with the selected execution paths; and
fusing the determined computer code parameters and hardware performance data to form a kernel for inputting to a trained model.

16. The computer-implemented method of claim 15, wherein the selected execution paths are associated with respective sequences of functions.

17. The computer-implemented method of claim 15, wherein tracking the symbols includes determining at least one of a number of calls or a standard deviation associated with each of the symbols.

18. The computer-implemented method of claim 15, wherein the respective scores are based on runtimes associated with the execution paths.

19. A computer-implemented method for training a model to predict anomalous computing environment behavior, comprising:
generating model training data comprising a plurality of reference data patterns associated with non-anomalous behavior by fusing sets of computer code parameters with respective hardware performance datasets;
inputting the model training data to a model to prompt the model to generate a model training output;
receiving the model training output from the model; and
updating the model based on the model training output, thereby training the model to detect execution performance anomalies inconsistent with at least one of the reference data patterns.
